(19) United States
(12) Patent Application Publication
(10) Pub. No.: US 2014/0081938 A1
(43) Pub. Date: Mar. 20, 2014

(54) BIDIRECTIONAL SYNCHRONIZATION OF COMMUNICATIONS AND CRM APPLICATIONS

(71) Applicants: Wayne Parker, III, Seattle, WA (US); Navin Thadani, Bothell, WA (US); Tong Gao, Redmond, WA (US); Ron Mondri, Bellevue, WA (US); Indrojit Deb, Sammamish, WA (US); Praveen Upadhyay, Hyderabad (IN); Ian Legler, Redmond, WA (US)

(72) Inventors: Wayne Parker, III, Seattle, WA (US); Navin Thadani, Bothell, WA (US); Tong Gao, Redmond, WA (US); Ron Mondri, Bellevue, WA (US); Indrojit Deb, Sammamish, WA (US); Praveen Upadhyay, Hyderabad (IN); Ian Legler, Redmond, WA (US)

(73) Assignee: Microsoft Corporation, Redmond, WA (US)

(21) Appl. No.: 13/619,052

(22) Filed: Sep. 14, 2012

(51) Int. Cl. G06F 7/00

(52) U.S. Cl. 707/705; 707/E17.005; 707/E17.032

(57) ABSTRACT

Synchronization between Communications and Scheduling (CS) service and customer relationship management (CRM) applications is facilitated through a synchronization module on the CS service side using Extensible Markup Language (XML) formatted storage for keeping track of synchronization states. The CRM server version of an item is compared with the XML formatted storage to detect changes and the same performed for the CS service item. The updates are stored in a CS service item or transmitted to the CRM application for application to a corresponding CRM item. Last updated item is selected in case of a conflict.

### BACKGROUND

Customer Relationship Management (CRM) solutions provide tools and capabilities needed to create and maintain a clear picture of customers, from first contact through purchase and post-sales. For complex organizations, a CRM system may provide features and capabilities to help improve the way sales, marketing, and/or customer service organizations target new customers, manage marketing campaigns, and drive sales activities. CRM systems may include many components, hardware and software, utilized individually or in a shared manner by users internal or external to the organization.

CRM systems are an example of computing systems where data associated with entities such as persons, organizations, accounts, and similar ones are maintained for various purposes. Some of the information collected and maintained by CRM applications may also be collected by other common applications such as a communications and/or scheduling service (for example, Exchange Server® or Exchange Online® by Microsoft Corporation of Redmond, Wash.). When users have similar information maintained by two or more applications, a logical action is to synchronize the information in order to enhance efficiency and accuracy. While some applications are capable of synchronizing maintained information, conventional synchronization approaches are relatively unreliable, resource-expensive, and cannot take full advantage of enhanced capabilities such as delegation or search.

Modern solutions also lack in user privilege accommodation when maintaining synchronization across platforms. Providing access to a user's content in one platform does not propagate to a companion platform maintaining same or similar content. In most current platforms, alternate user access scenarios require the alternate user to duplicate work by authenticating in multiple platforms and duplicating the process of updating a user's content.

### SUMMARY

This summary is provided to introduce a selection of concepts in a simplified form that are further described below in the Detailed Description. This summary is not intended to exclusively identify key features or essential features of the claimed subject matter, nor is it intended as an aid in determining the scope of the claimed subject matter.

Embodiments are directed to enabling synchronization of information between a CRM application and a Communications and Scheduling (CS) service through a synchronization module. According to some embodiments, a CS service may be enabled to synchronize data associated with emails, contacts, scheduling events, and tasks with data maintained by the CRM application through a single or multi-threaded process employing cache. In addition to ensuring efficient synchronization, delegates may be authenticated and authorized to provide updates for relevant data in the CS and CRM applications through a web service of the CS service.

These and other features and advantages will be apparent from a reading of the following detailed description and a review of the associated drawings. It is to be understood that both the foregoing general description and the following detailed description are explanatory and do not restrict aspects as claimed.

### BRIEF DESCRIPTION OF THE DRAWINGS

FIG. 1 illustrates a networked environment, where a CS service may manage synchronization between the CS and CRM applications according to some embodiments;

FIG. 2 illustrates example actions and components in synchronization of a CRM application based on changes at a CS service;

FIG. 3 illustrates example actions and components in synchronization of a CS service based on changes at a CRM application;

FIG. 4 illustrates updating of cache records prior to and following synchronization in a system according to some embodiments;

FIG. 5 is a networked environment, where a system according to embodiments may be implemented;

FIG. 6 is a block diagram of an example computing operating environment, where embodiments may be implemented; and

FIG. 7 illustrates a logic flow diagram for a process of synchronizing CS and CRM applications data according to embodiments.

### DETAILED DESCRIPTION

As briefly described above, bidirectional synchronization between CS and CRM applications may be facilitated through a synchronization module on the CS service side using Extensible Markup Language (XML) formatted storage for keeping track of synchronization states. In the following detailed description, references are made to the accompanying drawings that form a part hereof, and in which are shown by way of illustrations specific embodiments or examples. These aspects may be combined, other aspects may be utilized, and structural changes may be made without departing from the spirit or scope of the present disclosure. The following detailed description is therefore not to be taken in a limiting sense, and the scope of the present invention is defined by the appended claims and their equivalents.

While the embodiments will be described in the general context of program modules that execute in conjunction with an application program that runs on an operating system on a computing device, those skilled in the art will recognize that aspects may also be implemented in combination with other program modules.

Generally, program modules include routines, programs, components, data structures, and other types of structures that perform particular tasks or implement particular abstract data types. Moreover, those skilled in the art will appreciate that embodiments may be practiced with other computer system configurations, including hand-held devices, multiprocessor systems, microprocessor-based or programmable consumer electronics, minicomputers, mainframe computers, and comparable computing devices. Embodiments may also be practiced in distributed computing environments where tasks are performed by remote processing devices that are linked through a communications network. In a distributed computing environment, program modules may be located in both local and remote memory storage devices.

Embodiments may be implemented as a computer-implemented process (method), a computing system, or as an article of manufacture, such as a computer program product or computer readable media. The computer program product may be a computer storage medium readable by a computer system and encoding a computer program that comprises instructions for causing a computer or computing system to perform example process(es). The computer-readable storage medium is a computer-readable memory device. The computer-readable storage medium can for example be implemented via one or more of a volatile computer memory, a non-volatile memory, a hard drive, a flash drive, a floppy disk, or a compact disk, and comparable media.

Throughout this specification, the term “platform” may be a combination of software and hardware components for providing CRM and/or email, contact, scheduling based services. Examples of platforms include, but are not limited to, a hosted service executed over a plurality of servers, an application executed on a single computing device, and comparable systems. The term “server” generally refers to a computing device executing one or more software programs typically in a networked environment. However, a server may also be implemented as a virtual server (software programs) executed on one or more computing devices viewed as a server on the network. More detail on these technologies and example operations is provided below.

The combined term CS service is used herein to collectively describe hosted, local, and/or distributed applications that provide email, scheduling, contact management, calendaring, and similar services with a server based architecture. Examples of such applications include Exchange Server® and Exchange Online® by Microsoft Corp. of Redmond, Wash. Such applications may provide access to one or more of the above listed functionality through a number of Application Programming Interfaces (APIs) such as web services. The applications may be executed on a server as a hosted service and accessed by users through thin clients such as browsers or locally executed client applications. Some of the services may be provided remotely, others may be provided locally. For simplicity, such applications are referred to collectively as CS services.

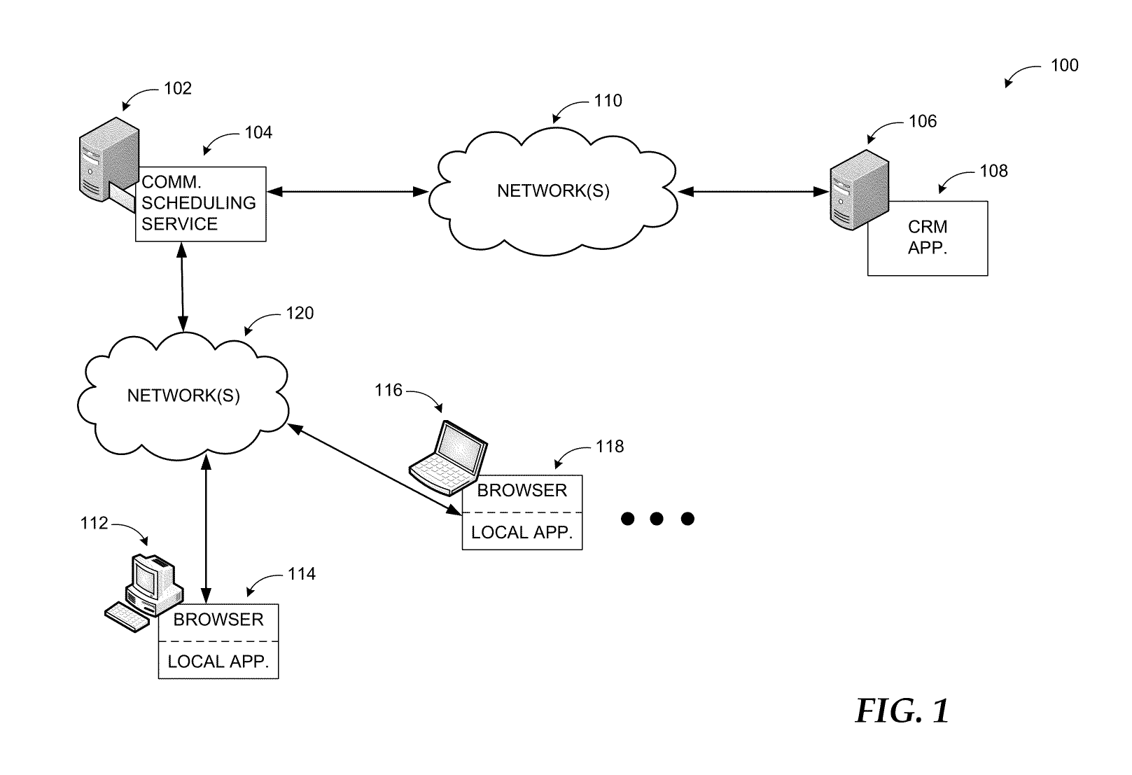

Referring to FIG. 1, diagram 100 illustrates a networked environment, where a CS service may manage synchronization between the CS and CRM applications according to some embodiments. The computing devices and computing environments shown in diagram 100 are for illustration purposes. Embodiments may be implemented in various local, networked, and similar computing environments employing a variety of computing devices and systems.

In an example environment illustrated in diagram 100, a CS service 104 may access a CRM application 108 executed on a CRM server 106 via network(s) 110. Users may access email, contact management, and/or scheduling services managed by a CS service 104 executed on server 102 through a browser or client application (114, 118) executed on their computing devices 112, 116 via network(s) 120. The networks 110 and 120 may be the same network. Alternatively, the networks 110 and 120 may be separate networks. In addition, the networks 110 and 120 may be components of a larger network.

Both, CS service 104 and CRM application 108 may collect and maintain information such as contact information, appointment/meeting information, email data, and comparable information. To avoid duplication of information on CS service and CRM sides, as well as to prevent conflicting data from being used, bidirectional synchronization may be performed employing a synchronization module executed in conjunction with the CS service.

Conventional synchronization approaches rely on messaging architecture and a Component Object Model, such as Messaging Application Programming Interface (MAPI)/RPC on change events, which may be inherently unreliable. Furthermore, column level discrepancies may not be reconciled between the server and the client, so that one always overwrites all data on the other. Traditional CS services do not allow delegated or shared mailboxes to be synchronized and do not take advantage of enhanced search capabilities.

Synchronization between Communications and Scheduling (CS) service and customer relationship management (CRM) applications is facilitated through a synchronization module on the CS service side using Extensible Markup Language (XML) formatted storage for keeping track of synchronization states. The XML formatted storage may be an XML file or an XML formatted small database stored in CS service memory. The CRM server version of an item is compared with the XML formatted storage to detect changes and the same performed for the CS service item. The changes are then pushed to the corresponding item for the columns that have changed. Last updated item is selected in case of a conflict.

Changes on the CS service side performed through an Application Programming Interface (API) such as a web service may enable a client application to update the CS service item. The web service may be a standardized web service used by the CS service to provide compatible access to third party client applications. Alternatively, the CS service may use a custom web service for each client. A custom web service may provide extensive interactions and additional features for a client at the cost of compatibility with other clients.

Computing devices 112 and 116 may be any computing device including, but not limited to, desktop computers, laptop computers, servers, handheld computers, vehicle mount computers, smart phones, and comparable devices.

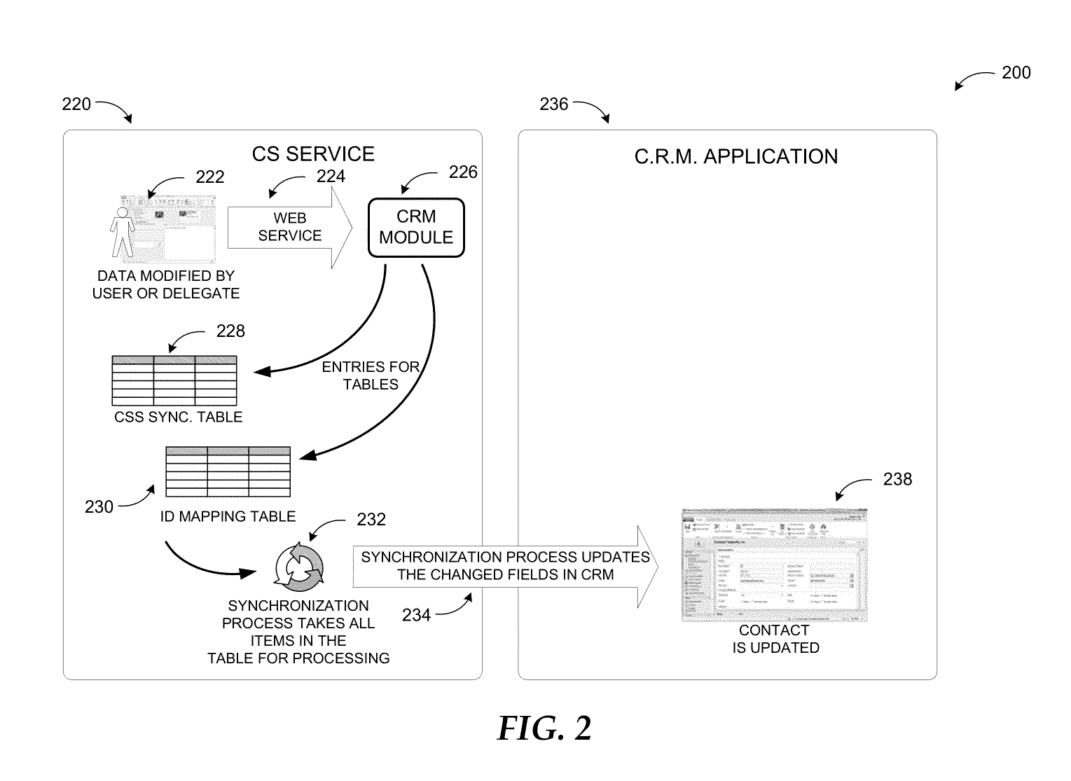

FIG. 2 illustrates, in diagram 200, example actions and components in synchronization of a CRM application based on changes at a CS service. Individual items (e.g., contacts, tasks, appointments, and emails) may be marked for synchronization in several ways. After marking an item for synchronization, two copies of that item exist: one copy residing in CS service 220 and the other copy residing in CRM application 236. In addition, modifications made to either copy of the item may be replicated in the other system via the synchronization process 232 managed by the CRM module 226. According to some embodiments, a client application may be enabled to control which CS service items are to be synchronized to the CRM application by using a tracking control associated with the CRM application.

For items that are modified in CS service 220, the process for synchronizing those changes with items in CRM application 236 may include CS service synchronization process 232 detecting changes (222) by monitoring web service change notifications 224, which CS service 220 may generate whenever an item is altered. When a web service notification is detected at the CRM module 226 for an item that is marked for synchronization, an entry recording this may be added to a CS service synchronization table 228 in the CS service cache. This ensures that changes to CRM tracked items at the CS service are retrieved by the CRM application 236 even when these changes occur in absence of the CRM module 226.

The CS service cache, created by the CRM module 226, may be a compact database that is located on the server and is used to store information about synchronized items for use by the synchronization process. The cache may contain information that is needed to identify and locate items in CS and CRM applications, as well as changes to those items that are made by either system, to re-attempt synchronization for changes that fail to synchronize. An ID mapping table may be mainly used to store the item mapping between CRM and CS, which can be used to get the item by the identifier instead of scanning the CS or CRM system. This ensures that the CRM module has a ready reference to establish whether a change indicates that a new record needs to be added or that it requires an existing record to be modified without doing resource-costly scans on CS service. As a result, faster synchronization may be accomplished without significant impact on CS service performance. The CS service cache may be XML formatted storage as stated above. The XML formatted storage may be an XML file.

Under certain circumstances, for example, if a change occurs before the CRM module 226 is fully loaded, the CRM module 226 may miss web service notifications. To mitigate such scenarios, installation of the CRM module 226 may create a web service contents table, which stores all items that are marked for synchronization, sorted in reverse order based on modification date. As a result, any missed change notifications (except for delete notifications) may be retrieved the next time the system scans the web service contents table for the synchronized folders for all items that have been changed since the last synchronization occurred. Items in web service contents table may be processed one by one until the last synchronization time is reached.

Thus, the CS service cache may include at least two tables: the ID mapping table 230 and the CS service synchronization table 228. For items that have been deleted, a periodic reconciliation may be performed to look at items in the CS service cache and to verify the existence of the items in the CS service data store. If an item cannot be found, a deletion entry may be added to the CS service synchronization table 228. Two example tables with example data and value types are shown below.

TABLE 1
Example ID Mapping Table

| Column | Value Type |
|---|---|
| MapID | Primary Key |
| CRMID | Unique Identifier |
| EntryID | Variable character string |
| ObjectType | Integer |
| DeletedLocally | Bit |
| Visited | Bit |
| VerifiedTime | Date & time |

TABLE 2
Example CS service Synchronization Table

| Column | Value Type |
|---|---|
| ChangeID | Primary Key |
| MapID | Foreign Key |
| ClientTimestamp | Date & time |
| ClientChange | Integer |
| CRMTimestamp | Date & time |
| CRMChange | Integer |

Synchronization process 232 may retrieve the items from the tables for processing and update the changed fields in the CRM application (234). For example, changes to a contact in CS service 220 may be reflected in the contact 238 in CRM application 236 following the synchronization process 232.

According to some embodiments, the CS service may authenticate a delegated user at the web service as the provider of an update for a CS service item. The CS service may provide access privileges associated with an owner of the CS service item to apply the update. The update may be applied at a shared mailbox of the owner. An example may include updating changed contact information provided by a delegate at an email account of a user within a shared mailbox. Shared mailbox may be managed by the CS service. However, in certain scenarios, the CRM application may manage the shared mailbox and/or store it. In addition, the CS service may limit update actions for the update according to a privilege level of the delegate. An example may include a delegate with fewer privileges compared to an owner of the CS service or CRM item. In such a scenario, the CS service may only activate actions within the realm of the delegate privileges. In an example, the CS service may only enable the delegate to update common information, such as location, of a contact while blocking update of private information such as address or phone number of a contact.

According to other embodiments, the CS service may label the CS service item with a tag for synchronization subsequent to receiving the update from an authenticated delegate. The CS service may initiate the process for the update subsequent to activation of the process as a result of detecting the tag through a scheduled or manual search of the tag within the ID mapping table 230.

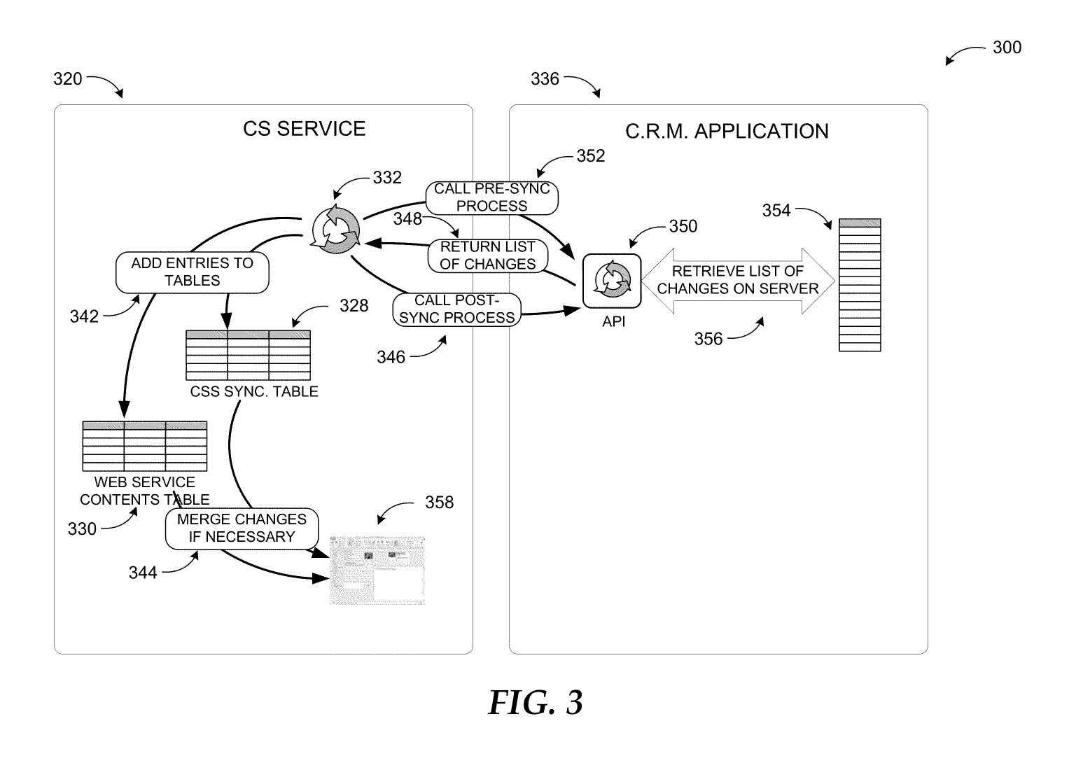

FIG. 3 illustrates, in diagram 300, example actions and components in synchronization of a CS service based on changes at a CRM application. Changes on the CRM application (336) side may be retrieved by the synchronization process 332 calling (352) prepare synchronization Application Programming Interface (API) 350 on the CRM server, which identifies a number of items on the CRM server that have changed (356) for a particular server and returns (348) that summary information since the last time a successful synchronization of such changes was performed. With this information, a call to retrieve synchronization data (346) may be made against the server with a column set 354 that contains the CRMID and the time stamp of the changed items.

For the items retrieved in this way, a post-synchronization API may be called to identify to the CRM server that the change on each item has been processed. The items may then be added (342) to the CS service cache in the CS service synchronization table 328 for later processing. CS service 320 may also include ID mapping table 230 and merge the changes from both tables if needed (344) resulting in an updated item 358 (e.g., an updated contact card).

In a system according to embodiments, synchronization is bi-directional. Thus, the CS service 320 synchronizes with the CRM application 336 and vice versa. After the synchronization process is performed, the most recent synchronized version of an item may be saved in XML format and stored in a property of the item. An update may be stored as a previous state of the CS service item in the XML file as a property of the CS service item.

When an item is changed in either CS service or CRM, the item may be synchronized such that the change appears in both systems by comparing column differences using the XML record of the item from CS service and timestamps of the changes. When an item is changed in both CS and CRM applications, bi-directional synchronization may occur according to the timestamps of the changes, so that the most recent change takes precedence and overrides any earlier ones.

For example, when a synchronized item is altered in CRM after a change on the corresponding item in CS service, CRM to CS service synchronization may be performed to synchronize the latest changes that have been made to the item in CRM over to the corresponding item in CS service, and the XML record associated with the CS service item may be updated. Then, the system may perform a CS service to CRM synchronization to ensure that the latest changes to the CS service item are synchronized with the corresponding item in CRM.

According to some embodiments, the CS service may store an update for a CS service item received from a web service of the CS service in the CS service cache. The CS service may also store an update to the CS service item retrieved from a corresponding CRM item in the CS service cache. The CRM application may be queried for an updated CRM item in response to one or more from: expiration of a predefined time period, a system event, and a manual activation by a client application. Alternatively, the CRM application may be queried for an update from a corresponding CRM item in response to detection of a change in the CS service item and a notification marking the CS service item for synchronization. Additionally, the CS service may accommodate a request received from a client application for synchronization through a web service of the CS service.

According to other embodiments, the CS service or the CRM module may execute a single thread process or a multi-threaded process utilizing parallel computing to manage an update to the CS service item. Additionally, the CS service may maintain the XML storage as a compact database at the CS service for storing information associated with the CS service and corresponding CRM items. The information associated with the CS service and corresponding CRM items may include identification data and location data for the items on the CS and the CRM applications, and change information from the CS and the CRM applications for changed items.

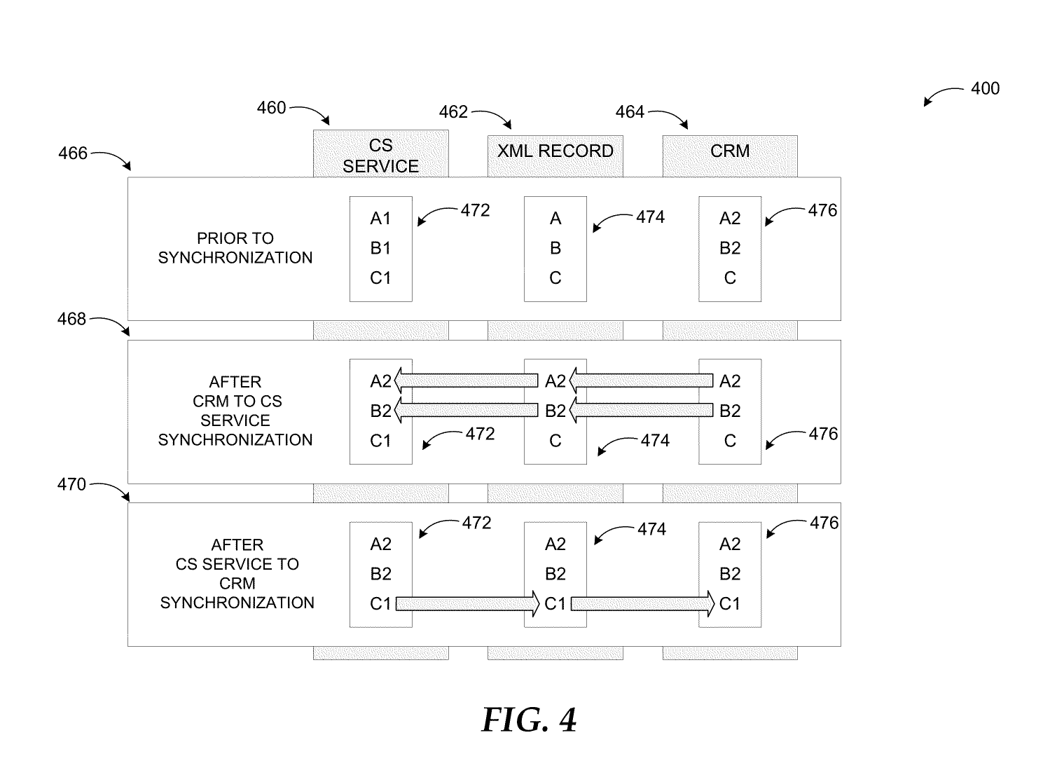

FIG. 4 illustrates updating of records prior to and following synchronization in a system according to some embodiments. Diagram 400 provides an example of the process associated with merging overlapping changes between CRM and CS applications.

According to the example scenario, prior to synchronization (466), an update event at a web service of the CS service makes changes to three fields (A1, B1, and C1) 472 in an item in CS service 460. XML file 462 maintains original record of the item (A, B, and C) 474. At a later time, the same event or another event makes changes to corresponding item in CRM 464, modifying two of the same fields (A2 and B2) 476 modified earlier by the CS web service. As a result, the CRM timestamp is more recent than the corresponding CS service timestamp.

During first phase of synchronization 468, the more recent field values in the CRM system (A2 and B2) 476 may be copied to the XML file 462 and then to the item in CS service 460, overwriting the earlier changes (A1 and B1) made to the item in CS service 460. When CRM to CS service synchronization (468) is complete, CS service to CRM synchronization 470 may occur, and the more recent field value in CS service 460 (C1) may be copied to the XML file 462 and then to the item in CRM 464, overwriting the original value (C).

In a system according to embodiments, the synchronization of CS service with CRM may be triggered when a web service marks an item for synchronization or alters a CS service item (such as a contact). Synchronization may also be triggered in response to a client application manually initiating CS service synchronization with CRM or a server synchronization operation beginning on a periodic basis. Manual as well as server synchronization may result in immediate replication of changes between CS service and CRM. When the web service marks an item for synchronization or alters a CS service item, the synchronization process may not always happen immediately (e.g., to allow time for the web service to complete a series of changes).

The examples in FIG. 2 through 4 have been described with specific configurations and components. Embodiments are not limited to systems according to these example configurations and components. Bidirectional synchronization between CRM and CS services may be implemented in configurations using other types of components, processes, and configurations in a similar manner using the principles described herein.

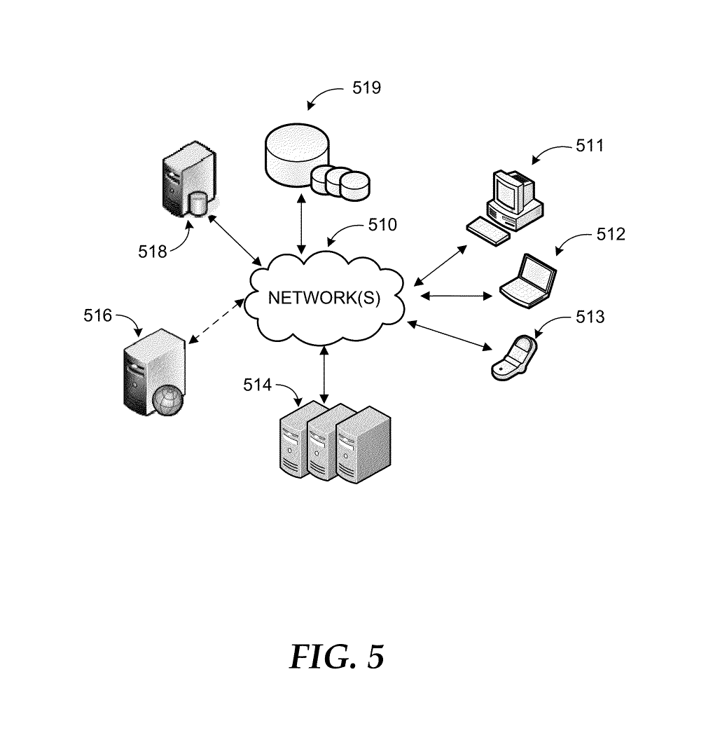

FIG. 5 is an example networked environment, where embodiments may be implemented. A system for bidirectional synchronization between CRM applications and CS services may be implemented via software executed over one or more servers 514 such as a hosted service. The platform may communicate with client applications on individual computing devices such as a smart phone 513, a laptop computer 512, or desktop computer 511 (‘client devices’) through network(s) 510.

Client applications executed on any of the client devices 511-513 may communicate with a CS service executed on one or more of servers 514. A synchronization module executed in conjunction with a CS service and a CRM application executed on server 516 may facilitate bidirectional synchronization of various forms of data maintained by the CS service and the CRM application as discussed previously. The CRM and/or CS services may retrieve relevant data from data store(s) 519 directly or through database server 518, and provide requested services (e.g. document editing) to the user(s) through client devices 511-513.

Network(s) 510 may comprise any topology of servers, clients, Internet service providers, and communication media. A system according to embodiments may have a static or dynamic topology. Network(s) 510 may include secure networks such as an enterprise network, an unsecure network such as a wireless open network, or the Internet. Network(s) 510 may also coordinate communication over other networks such as Public Switched Telephone Network (PSTN) or cellular networks. Furthermore, network(s) 510 may include short range wireless networks such as Bluetooth or similar ones. Network(s) 510 provide communication between the nodes described herein. By way of example, and not limitation, network(s) 510 may include wireless media such as acoustic, RF, infrared and other wireless media.

Many other configurations of computing devices, applications, data sources, and data distribution systems may be employed to implement a platform providing bidirectional synchronization between CS and CRM applications. Furthermore, the networked environments discussed in FIG. 5 are for illustration purposes only. Embodiments are not limited to the example applications, modules, or processes.

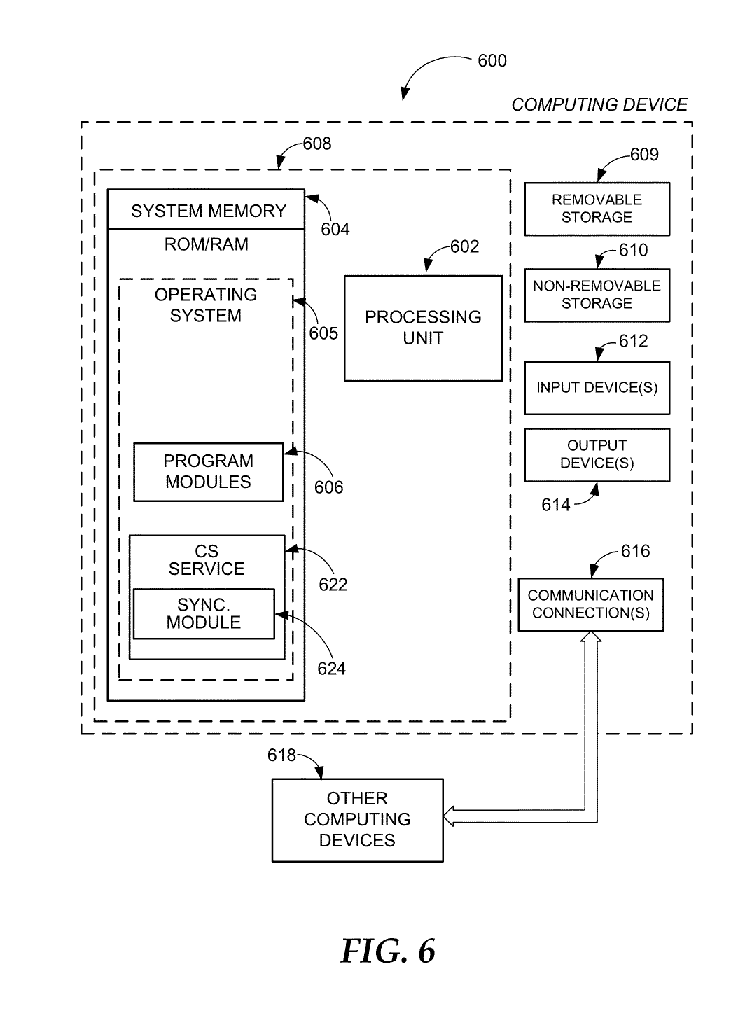

FIG. 6 and the associated discussion are intended to provide a brief, general description of a suitable computing environment in which embodiments may be implemented. With reference to FIG. 6, a block diagram of an example computing operating environment for an application according to embodiments is illustrated, such as computing device 600. In a basic configuration, computing device 600 may be any computing device executing an application capable of providing email, contact management, scheduling, and similar services, as well as access to a CRM application according to embodiments and include at least one processing unit 602 and system memory 604. Computing device 600 may also include a plurality of processing units that cooperate in executing programs. Depending on the exact configuration and type of computing device, the system memory 604 may be volatile (such as RAM), non-volatile (such as ROM, flash memory, etc.) or some combination of the two. System memory 604 typically includes an operating system 605 suitable for controlling the operation of the platform, such as the WINDOWS® operating systems from Microsoft Corporation of Redmond, Wash. The system memory 604 may also include one or more software applications such as program modules 606, CS service 622, and synchronization module 624.

CS service 622 may provide communications, scheduling and comparable services in conjunction with a hosted service. Synchronization module 624 may enable bidirectional synchronization of data such as contact information, email data, scheduling information, tasks, etc. between the CS service 622 and a CRM application using a single or multithreaded process and enabling enhanced features such as delegation accommodation, search capability, and the like. CS service 622 and synchronization module 624 may be separate applications or integrated modules of a hosted service. This basic configuration is illustrated in FIG. 6 by those components within dashed line 608.

Computing device 600 may have additional features or functionality. For example, the computing device 600 may also include additional data storage devices (removable and/or non-removable) such as, for example, magnetic disks, optical disks, or tape. Such additional storage is illustrated in FIG. 6 by removable storage 609 and non-removable storage 610. Computer readable storage media may include volatile and nonvolatile, removable and non-removable media implemented in any method or technology for storage of information, such as computer readable instructions, data structures, program modules, or other data. System memory 604, removable storage 609 and non-removable storage 610 are all examples of computer readable storage media. Computer readable storage media includes, but is not limited to, RAM, ROM, EEPROM, flash memory or other memory technology, CD-ROM, digital versatile disks (DVD) or other optical storage, magnetic tape, magnetic disk storage or other magnetic storage devices, or any other medium which can be used to store the desired information and which can be accessed by computing device 600. Any such computer readable storage media may be part of computing device 600. Computing device 600 may also have input device(s) 612 such as keyboard, mouse, pen, voice input device, touch input device, and comparable input devices. Output device(s) 614 such as a display, speakers, printer, and other types of output devices may also be included. These devices are well known in the art and need not be discussed at length here.

Computing device 600 may also contain communication connections 616 that allow the device to communicate with other devices 618, such as over a wired or wireless network in a distributed computing environment, a satellite link, a cellular link, a short range network, and comparable mechanisms. Other devices 618 may include computer device(s) that execute communication applications, web servers, and comparable devices. Communication connection(s) 616 is one example of communication media. Communication media can include therein computer readable instructions, data structures, program modules, or other data. By way of example, and not limitation, communication media includes wired media such as a wired network or direct-wired connection, and wireless media such as acoustic, RF, infrared and other wireless media.

Example embodiments also include methods. These methods can be implemented in any number of ways, including the structures described in this document. One such way is by machine operations, of devices of the type described in this document.

Another optional way is for one or more of the individual operations of the methods to be performed in conjunction with one or more human operators performing some. These human operators need not be collocated with each other, but each can be only with a machine that performs a portion of the program.

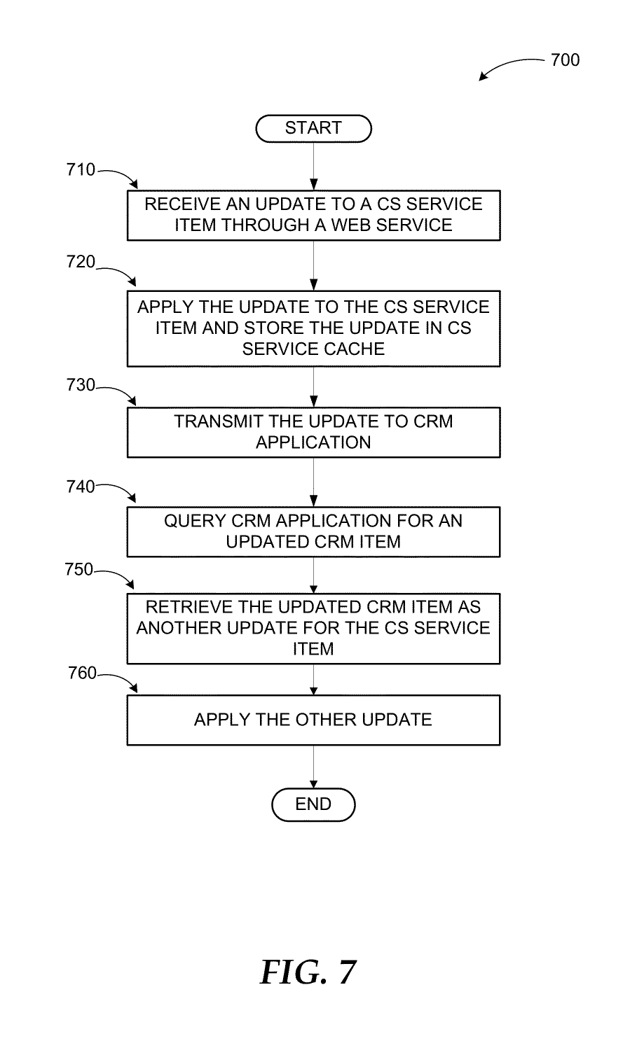

FIG. 7 illustrates a logic flow diagram for process 700 of synchronizing CS and CRM application data according to embodiments. Process 700 may be implemented on a server device.

Process 700 begins with operation 710, where the CS service may receive an update to a CS service item through a web service. The update may be provided by a client application interacting with the web service. At operation 720, the CS service may apply the update to the CS service item and store the update in CS service cache. The application may update an item such as a contact with update information such as new phone number and store the update in CS service cache which may be held in memory as a small database. Next, at operation 730, the application may transmit the update to the CRM application to update a corresponding CRM item.

For changes on the CRM side, the CS service may query the CRM application for an updated CRM item corresponding to a CS service item at operation 740. The CS service may retrieve the updated CRM item as another update for the CS service item at operation 750. Next, at operation 760, the CS service may apply the other update and store the other update in the CS service cache.

The operations included in process 700 are for illustration purposes. Bidirectional synchronization between CS and CRM applications may be implemented by similar processes with fewer or additional steps, as well as in different order of operations using the principles described herein.

The above specification, examples and data provide a complete description of the manufacture and use of the composition of the embodiments. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims and embodiments.

What is claimed is:

1. A method executed on a computing device for bi-directionally synchronizing items between a Communications and Scheduling (CS) service and a customer relationship management (CRM) application, the method comprising:
receiving an update to a CS service item through a web service of the CS service;
applying the update to the CS service item and storing the update in CS service cache;
transmitting the update to the CRM application;
querying the CRM application for an updated CRM item associated with the CS service item;
retrieving the updated CRM item as another update for the CS service item; and
applying the other update to the CS service item.

2. The method of claim 1, further comprising:
storing the other update to the CS service item in the CS service cache.

3. The method of claim 1, further comprising:
employing an Extensible Markup Language (XML) formatted storage as the CS service cache.

4. The method of claim 1, further comprising:
storing the update and the other update as a previous state of the CS service item in an XML file.

5. The method of claim 1, further comprising:
using the web service to query the CRM application and to receive the other update.

6. The method of claim 1, further comprising:
providing at least one of: a custom Application Programming Interface (API) and a standard API as the web service.

7. The method of claim 1, further comprising:
authenticating a delegated user at the web service as the provider of the update; and
providing access privileges associated with a user to apply the update.

8. The method of claim 7, further comprising:
applying the update to the CS service item of a shared mailbox of the user.

9. The method of claim 1, further comprising:
changing the CS service using the update and the other update, wherein the CS service item includes at least one from a set of: an email, a calendar event, a contact, and a task.

10. The method of claim 1, further comprising:
querying the CRM application for the updated CRM item in response to at least one from a set of: expiration of a predefined time period, a system event, and a manual activation.

11. A computing device for bi-directionally synchronizing items between a Communications and Scheduling (CS) service and a customer relationship management (CRM) application, the computing device comprising:
a memory;
a processor coupled to the memory, the processor executing the CS service and a CRM module integrated to the CS service, the CRM module configured to:
receive an update to a CS service item through a web service of the CS service;
employ an Extensible Markup Language (XML) formatted storage as CS service cache;
apply the update to the CS service item and storing the update in the CS service cache;
transmit the update to the CRM application;
query the CRM application for an updated CRM item associated with the CS service item;
retrieve the updated CRM item as another update for the CS service item;
apply the other update to CS service item and store the other update in the CS service cache; and
store the update and the other update as a previous state of the CS service item in a structured file.

12. The computing device of claim 11, wherein the CRM module is further configured to query the CRM application in response to one of:
detecting one of: a change in the CS service item and a notification as to the CS service item marked for synchronization; and
receiving a request from a client application for synchronization.

13. The computing device of claim 11, wherein the CRM module is further configured to:
execute a multi-threaded process utilizing parallel computing to manage the update and the other update to the CS service item.

14. The computing device of claim 11, wherein the CRM module is further configured to:
label the CS service item with a tag for synchronization subsequent to receiving the update from an authenticated delegate; and
initiate a process to apply the update subsequent to detecting the tag.

15. The computing device of claim 11, wherein the CRM module is further configured to:
maintain the XML storage as a compact database at the CS service for storing information associated with the CS service and corresponding CRM items.

16. The computing device of claim 15, wherein the information associated with the CS service and corresponding CRM items includes identification data and location data for the CS service item and the corresponding CRM item, and change information from the CS service and the corresponding CRM items.

17. A computer-readable memory device with instructions stored thereon for bi-directionally synchronizing items between a Communications and Scheduling (CS) service and a customer relationship management (CRM) application, the instructions comprising:
receiving an update to a CS service item from a delegate through a web service of the CS service;
labeling the CS service item with a tag for synchronization subsequent to authenticating the delegate;
initiating a process to update the CS service item subsequent to detecting the tag, including:
applying the update to the CS service item and storing the update in CS service cache;
transmitting the update to the CRM application;
querying the CRM application for an updated CRM item associated with the CS service item;
retrieving the updated CRM item as another update for the CS service item;
applying the other update to CS service item.

18. The computer-readable memory device of claim 17, wherein the instructions further comprise:
employing an Extensible Markup Language (XML) formatted storage as the CS service cache; and
maintaining the XML storage as a compact database at the CS service for storing information associated with the CS service and corresponding CRM items.

19. The computer-readable memory device of claim 18, wherein the instructions further comprise:
resolving update conflicts between the CS service items and corresponding CRM items according to a time stamp of the update and the other update and applying one of: the update and the other update according to most recent change taking precedence and overriding earlier changes.

20. The computer-readable memory device of claim 17, wherein the instructions further comprising:
limiting update actions for the update according to a privilege level of the delegate.
